(19) United States
(12) Patent Application Publication
(10) Pub. No.: US 2014/0058767 A1
(43) Pub. Date: Feb. 27, 2014

(54) RESERVATION REALIZATION SCORING SYSTEM AND METHOD

(71) Applicant: MASTERCARD INTERNATIONAL INCORPORATED, Purchase, NY (US)

(72) Inventor: Justin Xavier Howe, Oakdale, NY (US)

(73) Assignee: MASTERCARD INTERNATIONAL INCORPORATED, Purchase, NY (US)

(21) Appl. No.: 13/836,958

(22) Filed: Mar. 15, 2013

Related U.S. Application Data
(60) Provisional application No. 61/692,453, filed on Aug. 23, 2012.

(51) Int. Cl. G06Q 10/02

(52) U.S. Cl. CPC G06Q 10/02
USPC 705/5

(57) ABSTRACT

With the subject invention, a method is provided in which real-time information beyond point-of-sale is evaluated to determine a propensity score of a person realizing a reservation, in particular, whether the person shall be a no show or cancellation with respect to a reservation. The subject invention utilizes information obtained through a payment card network, which in the prior art has not been considered in evaluating no show or cancellation rates.

### CROSS-REFERENCE TO RELATED APPLICATION

This application claims priority to U.S. Provisional Patent Application No. 61/692,453, filed Aug. 23, 2012, the entire contents of which are incorporated by reference herein.

### BACKGROUND OF THE INVENTION

In the airline industry, techniques have been developed to statistically evaluate “no show” reservations. By predicting the level of no show reservations, better cost utilization and other benefits may be obtained through sale or transfer of the reservation and so forth.

Airlines typically evaluate historical data to predict customer no show behavior. Techniques have been also developed, such as that discussed in U.S. Pat. No. 7,415,422 to Selby, in which demographics and information specific to the reservation, are considered. With Selby, the following details may be taken into consideration: point-of-sale (POS) type transaction (travel agent, direct sale, etc.), POS country, booking carrier, booking recency (e.g., number of days since booking made), change recency (e.g., number of days since booking last changed), fare code, number of passengers travelling with the consumer making the reservation, length of stay associated with the reservation, time between booking date and flight time, and payment status.

### SUMMARY OF THE INVENTION

With the subject invention, a method is provided in which real-time information beyond point-of-sale is evaluated to determine a propensity score of a person realizing a reservation, in particular, whether the person shall be a no show or cancellation with respect to a reservation. The subject invention utilizes information obtained through a payment card network, which in the prior art has not been considered in evaluating no show or cancellation rates. The difficulty with utilizing such information is privacy laws. For example, under U.S. privacy laws, information collected about an individual over a payment card network can not be freely disseminated. To avoid these difficulties, the subject invention utilizes a propensity score to represent likelihood of cancellation or no show. Separate propensity scores for cancellation and no show may be provided. In this manner, specific personal details leading to a score representing high likelihood of cancellation and/or no show will not be shared with an airline or other vendor.

These and other features of the invention will be better understood through a study of the following detailed description and accompanying drawings.

### BRIEF DESCRIPTION OF THE DRAWINGS

FIG. 1 is a schematic showing a system useable with the subject system, and;

FIG. 2 is a flowchart representing a method in accordance with the subject invention.

### DETAILED DESCRIPTION OF THE INVENTION

The subject invention calls for collecting and analyzing details at an individual consumer level based on information collected over a payment card network. The system of the subject invention may be utilized to monitor activity of the consumer to evaluate propensity to realize the reservation as being possibly a no show or cancellation. It is noted that any form of payment over a payment card network may be utilized within the system. Preferably, the monitoring and evaluation of the consumer shall be conducted in real-time to provide latest information to vendors. The system may be initiated by particular transactions or by prompting of a vendor.

The subject invention provides many advantages, including the benefit of evaluation of information not accessible to vendors, such as airlines. The evaluated information may include conclusions drawn from various financial transactions of the consumer. For example, the distance from the location of a reservation, such as an airport, optionally in combination with timing, of a transaction may be an indicator that the consumer will be a no show or cancellation.

In addition, the subject invention allows for monitoring of activity with respect to multiple vendors, such as multiple airlines, thus allowing the monitoring of information not accessible to individual vendors. For example, a conflicting purchase by the consumer may be noted where a separate airline ticket is purchased on a different airline that conflicts with the itinerary of an already-booked reservation. Likewise, other possible conflicting bookings may be reviewed, such as hotel stays or other travel arrangements (trains, cruises, etc.).

The details of the consumer's financial transaction will not be shared with the vendors to honor privacy laws. Rather, the system will generate propensity score(s) indicating likelihood of realizing the reservation, such score representing likelihood of no show and/or cancellation.

The method of the subject invention may be conducted without the consumer taking any additional steps. Depending on applicable law, consumers may need to be notified of the security process by their issuer and/or mobile network operator. In certain cases, their specific consent may be needed to include their information. In addition, due to ISO 8583 standards, information considered important to the evaluation with the subject invention is typically embedded in financial transactions. As such, the subject invention may be implemented with a system that is operatively connected to one or more payment card networks, with little or no modification of the respective payment card networks. The system can monitor, and evaluate in real-time, financial transactions.

The subject invention is particularly well-suited for application to the airline industry. The subject invention may be utilized to predict reservation realization, specifically cancellation/no show behavior, in other applications, such as the hotel industry, car rental industry, event industry (e.g. concerts, sporting events, etc.) and so forth. The subject invention may be utilized in connection with any reservation for a booking for a time specific event which is space-restricted to a number of participants, such as a reservation for a flight, cruise, train passage, restaurant seating, concert, sporting event, hotel stay, and so forth.

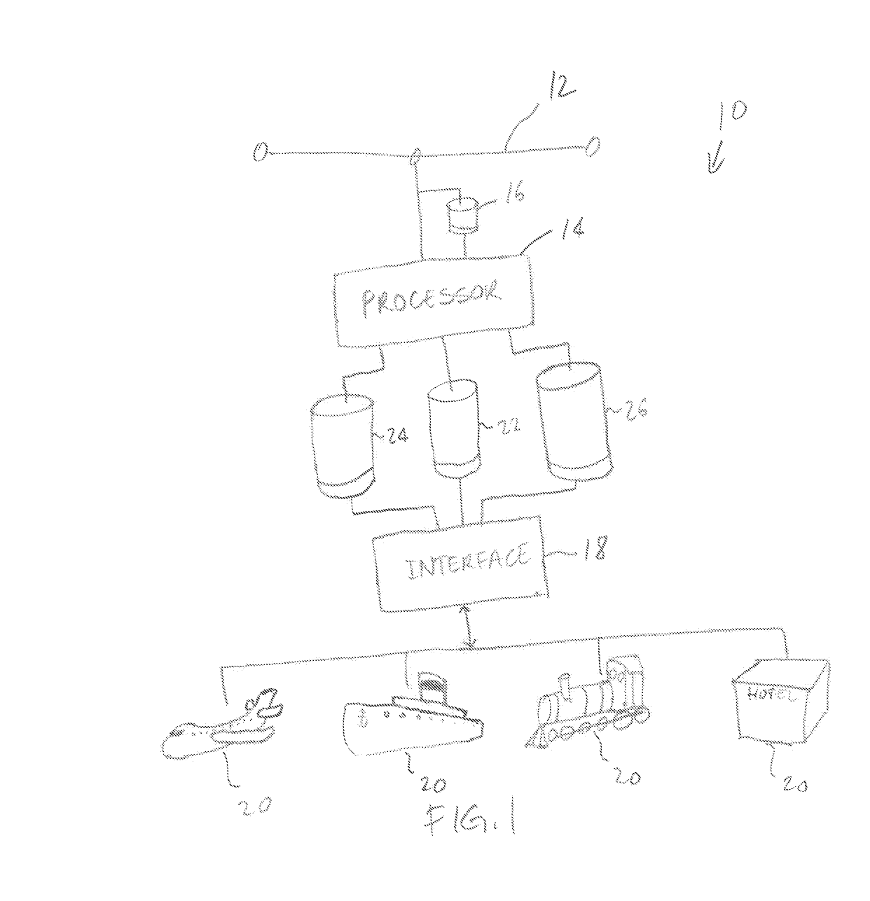

With reference to FIG. 1, a system 10 is shown useable to prepare a score representing the propensity of a consumer to realize a reservation. The failure to realize may be caused by cancellation or being a no show. The system 10 operates in conjunction with one or more payment card networks 12. As will be appreciated by those skilled in the art, any payment card network may be utilized, including traditional networks which communicate between vendors, acquirers, and issuers to authorize and clear consumer debit and credit transactions (such as, e.g., Automated Clearing House (ACH) network). The subject invention may be also used with wireless systems which are configured to access traditional networks. Further, the subject invention may be used with other systems for authorizing and clearing debit and credit transactions (such as smartphone or other wireless or web-enabled systems). As used herein, financial transactions refers to all debit and credit transactions, including, but not limited to, those based on payment cards, fobs (or other near-field-communication (NFC) devices), cellular phones, smartphones, and web-enabled systems.

A processor 14, which is a computing processing unit (CPU), is operatively linked, hard wired and/or wirelessly, to the one or more payment card networks 12. The processor 14 is configured to monitor financial transactions being transmitted over the one or more payment card networks 12. Such monitoring may be in real time. Little or no modification may be required to the one or more payment card networks 12 since the processor 14 only seeks to review the financial transactions and not make any changes.

To assist in processing, one or more buffers or other computer temporary storage units 16 may be utilized with the processor 14 to temporarily store passing financial transactions with such being queued for review by the processor 12. After review, the financial transactions may be deleted from the temporary storage units 16. The reference to real time herein is to both reviewing financial transactions contemporaneously with the financial transactions passing the processor 14, as well as, to reviewing financial transactions with some delay being caused by temporary storage of the financial transactions.

The processor 14 is configured to identify financial transactions which may be potentially relevant to determining a propensity score. The substantial majority of the financial transactions passing through the one or more payment card networks 12 shall not be relevant in making such a determination. In one variation, the processor 14 may identify financial transactions based on account numbers associated with target consumers. Once identified, the financial transactions may be evaluated as discussed below.

The system 10 may also include an interface 18 for communicating between one or more vendors 20 and the processor 14. The interface 18 may be operatively linked, hard-wired and/or wirelessly, with the vendors 20 through direct connections (hard wired, dial-in modem, wireless connection, and so forth) and/or through a network, such as a network of global computers (e.g., the Internet). As will be appreciated by those skilled in the art, the processor 14 and/or the interface 18 may be provided as a single computing processing unit (CPU) or as multiple computing processing units (CPUs) distributed over one or more networked locations.

The processor 14 and the interface 18 are operatively linked to an account database 22, a score database 24, and a historical data database 26. The databases 22, 24, 26 may be located on one or both of the processor 14 and/or the interface 18 and/or external devices (e.g., external hard drives). Any known computer-based database may be utilized. In addition, two or more of the databases 22, 24, 26 may be combined.

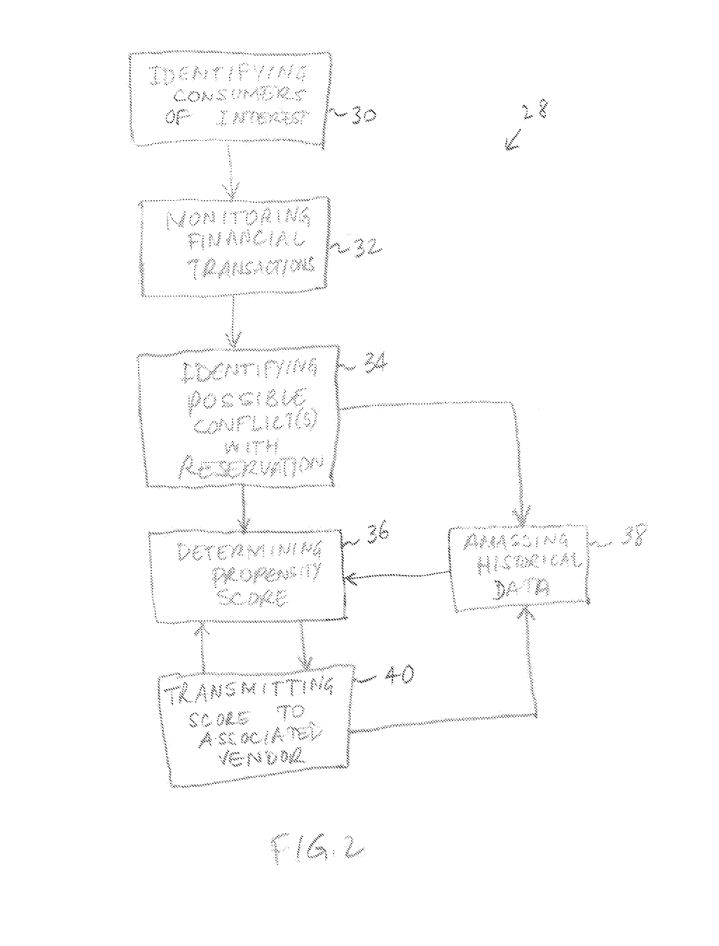

With reference to FIG. 2, a method 28 is shown including a first step 30 of identifying consumers of interest. In one variation, one or more of the vendors 20 may send a request to the interface 18 to monitor a particular consumer with respect to a particular reservation, for example, after a consumer makes a booking. In an alternative variation, one or more of the vendors 20 may set standing instructions for the system 10 to automatically monitor all transacting consumers which satisfy particular criteria. The standing instructions may set specific constraints, such as particular destinations, days and/or times of the week, number of booking participants, and so forth. In this manner, for example, a vendor 20 can set standing instructions to request automatic monitoring of bookings for certain business-oriented destinations, such as flights to Washington, D.C. and New York City. It is noted that under the laws of certain jurisdictions, the consumer's consent may be required to participate.

The processor 14 may be configured to identify financial transactions passing over the one or more payment card networks 12 which satisfy standing instructions and establish the reservations to be monitored. For example, all bookings with a particular airline may be identified based on standing instructions. The reservation particulars may be embedded in the associated financial transaction within the ISO 8583 information, e.g., within “level 2 or level 3” details. The processor 14 may be configured to send a message to the corresponding vendor 20, upon identifying a criteria-satisfying financial transaction, requesting details of the reservation where not included in the financial transaction.

The reservations to be monitored, along with associated account details (e.g., account number), may be stored in the account database 22. The account number may be utilized by the processor 14 to initially identify financial transactions which may be potentially relevant.

In a second step 32, the processor 14 monitors financial transactions over the one or more payment card networks 12 to identify financial transactions which are potentially relevant. Preferably, the processor 14 initially identifies financial transactions as being potentially relevant prior to fully evaluating the financial transaction. The processor 12 may identify financial transactions of the account numbers stored in the account database 22. The account numbers are transmitted as standard information in financial transactions.

In a third step 34, the financial transactions identified in the second step 32 may be evaluated for possible conflict with the reservation of interest. The processor 14 may draw various details (ISO 8583 information) from the financial transaction to evaluate the likelihood of the particular consumer realizing his/her reservation. The processor 14 may evaluate the financial transaction with consideration of the following factors:
Have any charges from prisons, jails, bail bondsmen or criminal attorneys been seen?
Did the consumer make a purchase far enough from the departure gate that reaching the flight in time is improbable?
Has the consumer made any other purchases of the same type of transaction (e.g., airline purchases) since initial booking with the vendor?
Has the consumer made any financial transactions indicating a booking conflict (e.g., a hotel booking which conflicts with a flight)?

In all, the processor 14 evaluates the financial transaction to determine if there is an indication that the consumer may or will not realize his/her reservation. Thus, a medical-related financial transaction or a criminal-charge related financial transaction may provide indication that there is a likelihood that the consumer shall not realize the reservation. Likewise, financial transactions conducted at geographically-distant locations relative to the location of the reservation are indicators of lower chance of realization. For example, a financial transaction conducted two states away from an airport for which there is a scheduled departure within an hour may be taken as an indicator that there is strong likelihood of no realization. Inconsistent bookings may be also taken into consideration. For example, a hotel booking overlapping a separately-booked flight may be taken as an indicator. With all of these factors, timing of the financial transaction relative to the scheduled time of the reservation should be taken into consideration. Under certain circumstances, the closeness in time will typically indicate a greater likelihood of no realization.

In fourth step 36, the processor 14 determines a propensity score based at least in part on the evaluation of the third step 34 which may be stored in the score database 24 associated with the consumer and the particular reservation. The information evaluated in the third step 34 is based on real time review of financial transactions over one or more of the payment card networks 12. Optionally, in addition, historical data may be taken into consideration in determining a propensity score. As indicated in the fifth step 38, consumer-related data may be stored in the historical data database 26 which may be retrieved and taken into consideration. The historical data may include data based on past financial transactions and past realizations (whether there was realization or failure to realize). Patterns from past financial transactions may be noted and utilized. Historical data may seek to review:
A consumer's historical tendency to make pre-reservation (e.g., pre-flight) purchases
How early does this consumer usually arrive to the location of the reservation (e..g, the airport) before their scheduled time (e.g, flight) (for example, as determined by examining post-check-in in-airport purchases that occur pre-flight).
Has daily spend pattern changed in the days before the reservation?
Use historical spend data to determine the reason for the trip: Family vacation, timeshare owner, business meetings, etc.
Has historical payment frequency dropped in the past few days, potentially indicating illness?
Does this consumer typically book with this vendor?
   Discrepancies with historical patterns may indicate a lower likelihood of reservation realization.

Based on the financial transactions, and the historical data to the extent utilized, a propensity score for realizing a reservation may be determined. The score may be stored on the score database 24. Known statistical methods may be used to determine the propensity score. The propensity score may be provided as a number, letter, color, symbol, and combinations thereof, of a scale extending from a high likelihood of realization to a low likelihood of realization. It is important to note that the propensity score provides no personal details relating to the financial transactions or historical data of the consumer. Rather, the propensity score is a representation of the likelihood of a particular behavior. This honors the consumer's privacy, yet provides a vendor with some indication of anticipated realization or failure thereof.

In a sixth step 40, the propensity score is transmitted to the relevant vendor(s) 20. The fourth step 36 may be conducted continuously in response to updated information (e.g., additional financial transactions) with the updated propensity score being transmitted. Alternatively, the score may be transmitted within a predetermined amount of time of the scheduled time of the reservation.

The system 10 may permit for a vendor 20 to send a message regarding the actual realization. Such information may be stored in the historical data database 26 and subsequently used to update the propensity score. The processor 14 may be also configured to identify refund requests transmitted over the one or more payment card networks 12 related to a reservation as indication of a no show or cancellation. The processor 14 may then automatically update the historical data database 26 with corresponding information.

The system 10 may be used to generate more than one propensity score for each reservation. For example, the system 10 may generate a no show propensity score and, separately, a cancellation propensity score for each consumer. Also, a group of propensity scores may be aggregated for a plurality of consumers prior to transmitting to one or more vendors with the aggregate score being transmitted to represent the propensity of the plurality of consumers to realize respective reservations. This may be necessary where privacy laws require a certain level of aggregation before sharing data derived from underlying consumer transactions. Aggregation may be established as microsegments in accordance with U.S. Published Patent Appl. No. 2013/0024242 to Villars, et al.

What is claimed is:

1. A method of evaluating consumer propensity to realize a reservation, said method comprising:
monitoring financial transaction activity of the consumer over at least one payment card network; and,
determining, based on said monitored financial transaction activity, a score representative of the propensity of the consumer to realize the reservation.

2. The method of claim 1, further comprising transmitting the score to a merchant associated with the reservation.

3. The method of claim 2, wherein the score is transmitted to the merchant upon a request by the merchant.

4. The method of claim 2, wherein the reservation is associated with a particular scheduled time, and wherein the score is transmitted to the merchant automatically within a predetermined amount of time of the scheduled time.

5. The method of claim 1, wherein said monitored financial transaction activity is reviewed to determine if one or more financial transactions represent a possible conflict to the consumer realizing the reservation.

6. The method of claim 5, wherein said monitored financial transaction activity is monitored in real time over the at least one payment card network.

7. The method of claim 6, wherein the score is continuously determined and updated in response to the real time monitoring of the at least one payment card network.

8. The method of claim 1, further comprising reviewing historical data related to the consumer in determining the score.

9. The method of claim 8, wherein the historical data includes information selected from the group consisting of previous reservation realizations, previous failures of the consumer to realize reservations, and combinations thereof.

10. The method of claim 1, further comprising aggregating scores for a plurality of consumers to generate a score representative of the propensity of the plurality of consumers to realize respective reservations.
